(19) United States
(12) Patent Application Publication
(10) Pub. No.: US 2004/0246114 A1
(43) Pub. Date: Dec. 9, 2004

(54) Image processing system for a vehicle

(76) Inventor: Stefan Hahn, Ulm (DE)

Correspondence Address: PENDORF & CUTLIFF, 5111 MEMORIAL HIGHWAY, TAMPA, FL, 33634-7356, US

(21) Appl. No.: 10/861,128

(22) Filed: Jun. 4, 2004

(30) Foreign Application Priority Data
Jun. 5, 2003 (DE) 103 25 762.4

(51) Int. Cl. B60Q 1/00

(52) U.S. Cl. 340/435

(57) ABSTRACT

In order to assist the driver, future vehicles are being equipped with systems for detecting the surroundings. Such systems serve to provide the driver with advance warning about possible collisions with other participants in traffic, for example, pedestrians. Here, the detection of the information about the surroundings is done, among others, using image sensors and their evaluation via an image processing unit. The evaluation of image data is limited to simple geometric and dynamic models which describe the behavior of participants in traffic. Therefore, an image-processing system is proposed which takes into consideration the attention of other participants in traffic. Especially here, the direction of looking of recognized participants in traffic is detected and, based on the detected direction of looking, a probability is determined for evaluating the risk of collision with other participants in traffic. In case the collision risk exceeds a certain determined threshold value, measures are initiated for avoiding a collision.

### BACKGROUND OF THE INVENTION

1. Field of Invention

The invention concerns a method for the operation of an image processing system for a vehicle as well as an image processing system for a vehicle, and in particular for avoiding collisions with other participants in traffic.

2. Related Art of the Invention

In order to assist the driver, future vehicles will be equipped with surroundings-detecting systems. Such systems serve to warn the driver about obstacles and other sources of danger, in order to reduce the number of accidents. Using optoelectronic detection of the surroundings in front of the vehicle, the driver can, for example, be warned early about possible collisions with other participants in traffic. The detection of the information about the surroundings is done here with the aid of imaging providing sensors, where the detected image data are then evaluated with an image processing system. The evaluation is mostly done by checking if the distance to an obstacle or a participant in traffic is less than a permissible minimum distance.

U.S. Pat. No. 6,496,117 B2 describes a system for monitoring the attentiveness of a driver. For this purpose, the system has a camera which scans the face of a driver. Furthermore, the system includes a unit for the determination of the direction of looking as well as the position of the face of the driver. Thus, it is determined if the direction of looking as well as the position of the face of the driver are oriented to the direction of the travel ahead of the vehicle, Furthermore, the system is equipped with a warning device which warns the driver in case his direction of looking or the position of his face is not oriented in the direction of driving in front of the vehicle. Additionally, a camera detects objects in the surroundings of the vehicle, where the detected objects are evaluated, especially the nature of the object and the distance of it to the vehicle. In this way, a warning signal is triggered depending on the direction of looking and position of the face of the driver, and also if the distance at the same time is less than the minimum distance to objects.

In JP 2002250192 A a method is described for use in vehicles for preventing collisions with other participants in traffic. Information for avoiding collisions is made available which includes the behavior of other participants in traffic. Especially, the risk of collision is evaluated here by evaluating the behavior of other participants in traffic with respect to the vehicle in question. Based on this evaluation, it is then determined if the brakes of the vehicle can be operated at the right time in case of danger of collision. The method is described with the aid of a pedestrian who is located near a street crossing with a total of 4 pedestrian crosswalks (“zebra stripes”). Here, with the aid of geometric information of the scene, of the position of the pedestrian as well as his direction of movement, it is evaluated which of the 4 pedestrian crosswalks the pedestrian will cross. In addition, for the evaluation of future behavior of the pedestrian, the waiting times at the traffic lights as well as his speed of movement is taken into consideration. Here in the method, a uniform movement model of the pedestrian is utilized, where, for example, the usual speeds of movement of pedestrians at traffic lights are known. However, a disadvantage here is that, the evaluation of other participants in traffic is done relatively inaccurately. Specifically, in the evaluation only simple geometric models and simple movement models of other participants in traffic are taken into consideration.

### SUMMARY OF THE INVENTION

Therefore, the task of the invention is to provide a method for the operation of an image processing system for a vehicle according to the main clause of Patent Claim 1 as well as an image processing system for a vehicle according to the main clause of Patent Claim 11, with which reliable detection of persons should be made possible, especially with regard to possible evaluation of a risk of collision.

The task is solved according to the invention by a method with the characteristics of Patent claim 1 and with an image processing system with the characteristics of claim 11. Advantageous embodiments and further developments of the invention are given in the subclaims.

According to the invention, a method is proposed for the operation of an image processing system for a vehicle. Here, the proposed image processing system includes at least one image sensor for the detection of information about the surroundings, where the detected information about the surroundings is evaluated with a computer unit in order to recognize the existence of participants in traffic. In a method of the invention, the direction of looking of one or several recognized participants in traffic is detected. With the invention, it is made possible to a special degree to obtain reliable person recognition especially with regard to possible evaluation of a risk of collision, for example, by taking into consideration the attention of the participants in traffic. Here, recognition of the participants in traffic does not mean their identification, but checking of their existence in the data about the surroundings. Methods for the recognition and following of participants in traffic, especially of pedestrians, are known, for example, from D. M. Gavrila, “Sensor-based Pedestrian Protection”, IEEE Intelligent Systems, Vol. 16, No. 6, pp. 77-81, 2001, and D. M. Gavrila and J. Giebel, “Shape-based Pedestrian Detection and Tracking”, Proc. of IEEE International Conference on Intelligent Vehicles, Paris, France, 2002. The image-based object recognition in combination with driver assistance system is described in general in U. Franke, D. M. Gavrila, A. Gern, S. Gorzig, R. Janssen, F. Paetzold and C. Wöhler, “From Door to Door -Principles and Applications of Computer Vision for Driver Assistant Systems”, Chapter 6 in Intelligent Vehicle Technologies, Editors L. Vlacic and F. Harashima and M. Parent, Butterworth Heinemann, Oxford, 2001. With object recognition, the direction of looking of the participant in traffic can be determined well, as a result of which the reliability of the person recognition is enhanced. Based on the reliable person-recognition, timely warning of the driver and/or participant in traffic can be done before possible collisions, as a result of which, traffic safety is increased.

In an especially advantageous manner, the detection of the direction of looking of one or several participants in traffic is used for the evaluation of a risk of collision, where the direction of looking of a participant in traffic shows if this person is attentive and, for example, if an approaching vehicle is recognized by this participant in traffic. The collision risk is higher when the participant in traffic looks in a direction opposite to the image sensor than when he looks directly in the image sensor. The risk of collision is higher if another participant in traffic looks only roughly in the direction of the driver than when he has direct eye contact with the driver.

In a further advantageous manner, the dependence of the detected and evaluated direction of looking of recognized participants in traffic forms a measure of probability for evaluation of the risk of collision. Here, there is a possibility that the probability measure can be determined directly from the relative angle between the direction of looking of the participant in traffic and the image sensor or between the direction of movement of the vehicle or that of the participant in the traffic. Here the probability of collision risk, for example, increases proportionally with this angle. However, in connection with the image processing system, it is also conceivable that image sections of participants in traffic are stored in different poses. The image sections are stored so that these can be utilized within the framework of a training process for a classification method as random examples. Here, within the framework of a classification, each class yields a measure of probability for the attention of the participant in traffic and thus for the collision risk. In addition to the direction of looking, the duration of the eye contact can also be used for the evaluation of the risk of collision. Here it can be determined, for example, if an approaching vehicle is actually noticed by the participant in traffic or if eye contact possibly occurred only accidentally.

The detected information about the surroundings can be compared with stored model information and from that a probability measure can be formed for the evaluation of the risk of collision. Here, the model data can be stored both in static as well as in dynamic databases. These can be model data which describe both the scene as well as other participants in traffic as well as their vehicles and their movement. For this purpose, for example, geometric and dynamic model data are used in order to describe the behavior of pedestrians, for example, when crossing a street with pedestrian island and without pedestrian island or with pedestrian crossing. It is also conceivable that, in combination with strictly established rules, a probability measure can be developed for evaluating the collision risk. For example, here the so-called “if-then-else” clauses or automatic models can be utilized. In another advantageous manner, based on information about the movement of the vehicle and/or of other(s) recognized participants in traffic, a probability measure can be formed for evaluating the risk of collision, for example, the movement information can be about speed, direction as well as trajectory, with which a vehicle and/or a recognized participant in traffic moves. In an especially advantageous manner; here the movement is determined relative to the driver's own vehicle in order to thus form a probability measure for the evaluation of the risk of collision, where the distance to the participant in traffic under consideration is determined, for example, with the aid of the image sensor. For example, in combination with 3D image sensors, this is directly possible, or, when using 2D image sensors, it can be realized using a stereo arrangement. Independently of this, however, it is also conceivable that, in combination with the image processing system according to the invention, an additional means is present which is suitable for determining the distance to other participants in traffic. For example, radar and ultrasound sensors, as well as GPS information are suitable for this.

In another advantageous manner, the partial probabilities which take into consideration the direction of looking and/or model information and/or strictly predetermined rules and/or movement information of the vehicle and/or of recognized participant(s) in traffic are combined to a total probability measure for the evaluation of the collision risk. Hereby, in case of the existence of several partial probabilities, it is also conceivable that only a part of these partial probabilities is used for the combination of the total probability measure. However, in case only one of the above partial possibilities exists, this forms the probability measure for evaluation of the collision risk.

A preferred embodiment of the invention provides that, depending on the probability measure or of the total probability measure at least one action is initiated with a control unit in order to reduce the collision risk. Here, for example, at least one collision-risk-reducing action is initiated as soon as the probability measure has exceeded a certain threshold value. For example, such actions are the following: acoustic warning signals which can warn the driver (buzzer) as well as other participants in traffic (horn), optical signals, braking or acceleration of the vehicle, deflecting movements or other actions that can be performed with the vehicle systems. As to which of these actions is performed can also depend on the magnitude of the probability. For example, in case of a low probability, first only the horn is activated. In case the probability increases further, for example, additionally the brake of the vehicle can be activated. Here, it is conceivable that the braking force will be changed depending on the probability.

It is also an advantage that, depending on the determination of the direction of looking, with the aid of a control unit, at least one action is initiated for reducing the risk of collision, and here no probability measure is formed for evaluating the risk of collision. In the simplest case, it is found as a result of the determination of the direction of looking, if there is eye-contact between the driver and another participant in traffic or not. For example, for this purpose, the relative angle between the direction of looking of the participant in traffic and the direction of movement of the image sensor, vehicle, or participant in traffic does not have to be calculated explicitly. For example, here, among others, already the eye contact between the driver and another participant in traffic can be used in case both eyes of the participant in traffic can be recognized clearly in the image data. Naturally, in this connection, other evaluation methods can be conceived, where a probability measure does not necessarily have to be calculated and where the result of the particular evaluation can be imaged directly in the output of the control unit.

Advantageously, the detected information about the surroundings is 2D and/or 3D image information. For this purpose, passive imaging sensors, for example, standard video cameras, can be used, and, similarly, the use of active image sensors, such as distance imaging cameras, can be conceived. Here, a combination of different optical sensors is also possible, where the sensitivity of the imaging sensors can lie both in the visible as well as in the non-visible wavelength region.

The invention is not limited to the use of motor vehicles. Rather, application of the image processing systems according to the invention and of the method for their operation can have an especially advantageous effect in other fields of application in connection with operating machinery. In the region of production areas, for example, frequently machine tools are used in the operating areas prohibited to personnel for safety reasons. These include, among others, lathes and milling machines, saws, grinders, etc., where, with the aid of the image processing system according to the invention, the working areas of these machines are monitored and the machine tools are turned off in a danger situation, thus increasing the traffic safety and hence the operational safety. The machine tool can also be a robot, where, in connection with robots, the evaluation of the viewing direction of persons can, for example, serve to improve the interaction between human and robot. Here, a stationary or mobile robot can be considered which can be operated autonomously.

### BRIEF DESCRIPTION OF THE DRAWING

Other features and advantages of the invention follow from the description of preferred practical example given below with reference to the figures. The following are shown:

FIG. 1 is a schematic structure of the image processing system

FIG. 2a is a traffic scene and a traffic participant which perceives an approaching vehicle.

FIG. 2b is an image section of a recognized participant in traffic with direct eye-contact with the driver

FIG. 3a is a traffic scene and a participant in traffic which does not perceive an approaching vehicle

FIG. 3b is a section of, an image of a recognized traffic participant who does not have eye-contact with the driver.

### DETAILED DESCRIPTION OF THE INVENTION

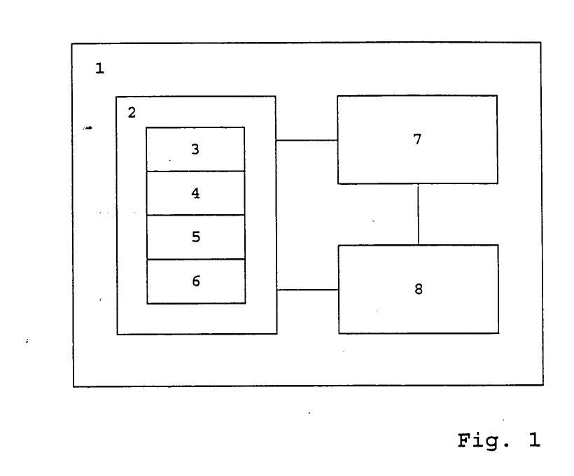

FIG. 1 shows as an example the schematic structure of the image processing system (1) according to the invention, where, using the image processing system (1), participants in traffic in the neighborhood of a vehicle can be detected and, in case these are moving, can also optionally be followed. Here, the traffic participants are especially persons or their vehicles. The traffic participants to be recognized can be known to the image processing system (1) where these are categorized according to classes and, for example, can be stored in the form of knowledge stored in memory (6) as learning examples. The classes can be, for example, pedestrian, cyclist, reflector posts, track marks, personal motor vehicles, trucks, bicycles, skateboard riders, etc.

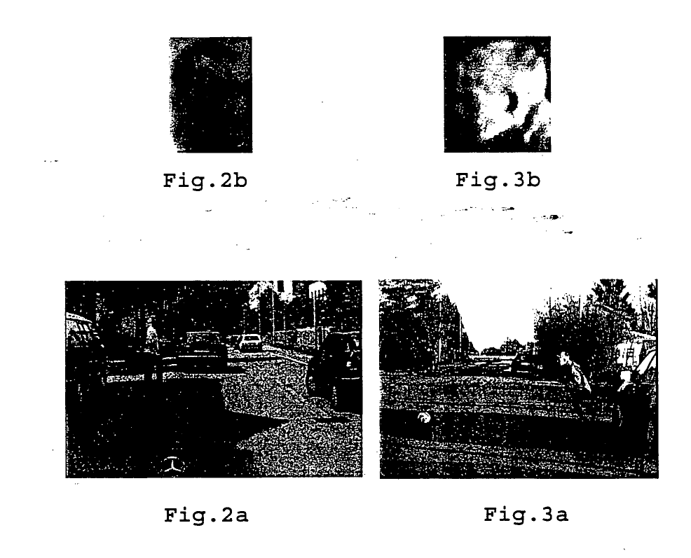

The image processing system (1) includes an object recognition unit (2), which has one or several image sensors (3), a computer unit (4) as well as an algorithm (5) for evaluating the imaging information. The image sensors (3) can be, for example, passive sensors, such as standard video cameras, or active sensors, for example, distance imaging cameras. For example, using a video-based object recognition unit (2), pedestrians can be recognized based on their external appearance and their 3D position can be evaluated based on calibrated camera parameters, with the assumption that these are located together with the vehicle on a horizontal plane. However, it is also conceivable that the classes of the traffic participants to be recognized are not known to the image processing system. In this case these are usually formulated based on a machine description based on their external spatial form. Here, the machine description naturally can also consider the trajectories of the participants in traffic. Furthermore, it is also conceivable that information regarding the participants in traffic is stored in static or dynamic databases, for example, in the memory (6) of the object recognition unit (2). It is also conceivable that information on participants in traffic is stored in an external memory connected to the image processing system. For example, the course of the travel path can be derived from sufficiently detailed electronic navigation databases. The objects recognized in connection with the object recognition unit (2) can appear, for example, as shown in the image sections in FIGS. 2b and 3b. Methods are known from the literature for the recognition of persons and their direction of looking from the images. For example, by direct searching of the image data for faces or by first determining the outside contours of persons in the image data and then, from these, determining the head regions, the determination of direction of looking can be carried out on the head regions with known techniques.

Furthermore, the image processing system (1) includes a unit for the evaluation of the risk of collision (7), for example, based on the direction of looking and/or on the movement of participants in traffic. In the evaluation of the risk of collision, using fixed rules, for example, if-then-else clauses, implicit imaging between the output of the object recognition system (2) and the control unit (7) is performed. This imaging can be carried out, for example, with the computer unit (4) or with another computer unit which is in connection with the image processing system (1). Such an implicit imaging can be produced, for example, by using the algorithms (5) for machine learning, for example, by training neuronal networks with the provision of random examples for a training, process. In the sense of the present invention, such a set of training rules, which, as stored knowledge of the image processing system, may contain the viewing or head direction of a participant in traffic in the image, as it is shown with the aid of image sections 2b and 3b. Here the fact can be used that the direction of the head is already a good approximation of the direction of viewing of persons. Naturally, the risk evaluation here is not limited to the use of neuronal networks, but other methods available to the person skilled in the art in the field of pattern recognition can be used, for example, an alternative is explicit imaging between the output of the object recognition system (2) and the control unit (8) with the aid of automatic models.

The control unit (8) serves for initiating actions which reduce the risk of collision. In case a probability measure formed with the unit for evaluation of the risk of collision (7) exceeds a certain threshold value, one or several actions are performed for reducing the risk of collision with the aid of the control unit (8). This can be, for example, a horn signal which warns other participants in traffic. An acoustic signal in the inside of the vehicle is suitable for warning the driver, for example, in case the driver looks in a direction other than the direction in front of the vehicle and there is a danger of collision.

Other examples for reducing the collision risk are, for example, braking, acceleration and deflection movements. In case that we are dealing with an automatically controlled vehicle with the aid of the control unit (8), the probability measure can be taken into consideration continuously in the control of the trajectory of the vehicle and, as a result of this, the probability of collision can be minimized.

FIG. 2a shows a traffic scene wherein a pedestrian is crossing a street. Based on his direction of looking, it is clear here that the pedestrian is attentive and notes the approaching vehicle. On the other hand, FIG. 3a shows a scene in which a pedestrian crosses a street where, based on the direction of looking, it can be assumed that the pedestrian has not noted the approaching vehicle. In FIGS. 2a and 3a the traffic participants can be clearly seen and are shown sufficiently large in order to recognize the direction of looking. For application in connection with street vehicles, here, as a rule commercial low-resolution cameras with 320×240 image points are sufficient. By using an algorithm known from S. Baker and T. Kanade, “Limits on Super-Resolution and How to Break Them”, IEEE Trans. On Pattern Analysis and Machine Intelligence, Vol. 24, No. 9, 2000, sufficient amplification of the recognition distance is achieved.

FIGS. 2b and 3b each show an enlarged image section from the traffic scenes represented in FIGS. 2a and 2b where especially the head of the recognized traffic participant is imaged. In FIG. 2b, the traffic participant has direct eye-contact with the driver, while the traffic participant in FIG. 3b does not have eye-contact with the driver.

1. A method for the operation of an image processing system for a vehicle, where, using at least one image sensor, information about the surroundings can be detected, and where the detected information about the surroundings is evaluated with a computer unit in order to recognize the presence of traffic participants,
wherein the direction of looking of one or several recognized traffic participants is detected.

2. The method for the operation of an image processing system according to claim 1,
wherein the detection of the direction of looking of one or several recognized traffic participants is used for the evaluation of their risk of collision.

3. The method for the operation of an image processing system according to claim 2,
wherein depending on the detected direction of looking of recognized traffic participants, a probability measure is formed for evaluating the risk of collision.

4. The method for the operation of an image processing system according to claim 1,
wherein the detected information about the surroundings is compared with stored model information and from that a probability measure is formed for evaluation of the risk of collision.

5. The method for the operation of an image processing system according to claim 1,
wherein depending on strictly predetermined rules, a probability measure is formed for evaluating the risk of collision.

6. The method for the operation of an image processing system according to claim 1,
wherein based on movement information of the vehicle and/or of recognized traffic participant(s), a probability measure is formed for the evaluation of the collision risk.

7. The method for the operation of an image processing system according to claim 1,
wherein partial probabilities, which take into consideration the direction of looking and/or model information and/or rigidly predetermined rules and/or movement information of the vehicle and/or that of recognized traffic participants, are combined to a measure of total probability for the evaluation of collision risk.

8. The method for the operation of an image processing system according to claim 1,
wherein depending on the probability measure or total probability measure, at least one action is initiated with a control unit to reduce the risk of collision.

9. The method for the operation of an image processing system according to claim 1,
wherein depending on the direction of looking, using a control unit, at least one action is initiated to reduce the risk of collision, wherein no probability measure is formed for evaluating the collision risk.

10. The method for the operation of an image processing system according to claim 1,
wherein the detected information about the surroundings is 2D and/or 3D image information.

11. An image processing system for a vehicle with at least one image sensor for the detection of information about the surroundings,
with a computer unit for performing person recognition from the data detected about the surroundings,
wherein the computer unit is designed so that it is suitable for the detection of the direction of looking of recognized participants in traffic from the detected data on the surroundings.

12. The image processing system according to claim 11,
wherein a unit is present for the evaluation of the risk of collision, which, based on the detected direction of looking and/or stored model information and/or strictly predetermined rules and/or motion information of the vehicle and/or of recognized traffic participant(s), forms a probability measure for evaluating the risk of collision.

13. The image processing system according to claim 11,
wherein a control unit is present which is suitable for initiating at least one collision-risk-reducing action depending on the risk of collision.

14. The image processing system according to claim 11,
wherein 2D and/or 3D image sensors are present for the detection of image information.

15. The image processing system according to claim 11,
wherein an additional means is present which is suitable for determining the distance to other participants in traffic.

16. A process for operating a machine tool, said machine tool being equipped with an image processing system with at least one image sensor for the detection of information about the surroundings and a computer unit for performing person recognition from the data detected about the surroundings, wherein the computer unit is designed so that it is suitable for the detection of the direction of looking of recognized participants in traffic from the detected data on the surroundings, and wherein said process comprises:
using said at least one image sensor to detect information about the surroundings,
evaluating the detected information about the surroundings with a computer unit in order to recognize the presence of personnel in the vicinity of said machine tool,
evaluating the direction of looking of recognized personnel, and
changing the condition of operation of said machine tool upon evaluating the possibility of danger to said recognized personnel.

17. A process as in claim 16, wherein said machine tool is a robot.

18. A process as in claim 16, wherein said machine tool is selected from the group consisting of lathes, milling machines, saws, and grinders.

19. A process as in claim 16, wherein upon recognizing the presence of personnel in the vicinity of said machine tool, said machine tool is turned off.
